(19) United States
(12) Patent Application Publication
(10) Pub. No.: US 2009/0068323 A1
(43) Pub. Date: Mar. 12, 2009

(54) LIQUID EDIBLE PRODUCTS AND METHODS OF STABILISING LIQUID EDIBLE PRODUCTS

(75) Inventor: Frederick Wade Mussawir-Key, Kent (GB)

Correspondence Address: PEARNE & GORDON LLP, 1801 EAST 9TH STREET, SUITE 1200, CLEVELAND, OH, 44114-3108, US

(73) Assignee: ST. GILES FOODS LIMITED, Kent (GB)

(21) Appl. No.: 11/718,658

(22) PCT Filed: Nov. 1, 2005
(86) PCT No.: PCT/GB2005/004217

§ 371 Date: Jul. 17, 2007

(30) Foreign Application Priority Data
Nov. 6, 2004 (GB) 0424615.3

(51) Int. Cl. A23D 7/00; B65D 85/72

(52) U.S. Cl. 426/115; 426/602; 426/116

(57) ABSTRACT

The invention provides a liquid edible product comprising a first liquid component, a second liquid component dispersed in the first liquid component to form an emulsion, and an emulsifier comprising a sucrose ester or a functionally equivalent derivative of a sucrose ester. The liquid edible product is of sprayable viscosity and may include edible oil and have use as a non stick cooking composition or a shallow frying oil.

The present invention relates to liquid edible products and methods of stabilising liquid edible products, and particularly but not exclusively to sprayable liquid edible products.

In order to enable liquid edible products, such as cooking oils, to be dispensed by means of, for example hand-held spray devices fitted with finger or trigger operated pumps (referred to hereinafter as finger pump actuated dispensers), with air pressure systems, compressed gases or low boiling point liquified gases (referred to hereinafter as aerosol dispensers), or devices comprising a pressurised container in which a flexible impervious bag is filled with product, the product must be of a sprayable viscosity. Most oils are too viscous at normal ambient temperatures to be readily sprayable and so oils are often mixed with water to form emulsions of lower, more readily sprayable viscosities.

However, the natural characteristics of oils and water are such that their emulsions have a tendency to separate into oil and water phases. This can adversely affect the properties of the sprayed product and thus result in a limited product shelf life.

According to a first aspect of the present invention, there is provided a sprayable liquid edible product comprising a first liquid component in an amount between 20 and 50% by weight, a second liquid component in an amount between 40-75% by weight dispersed in the first liquid component to form an emulsion, an emulsifier comprising a sucrose ester or a functionally equivalent derivative thereof in an amount up to about 5% by weight and a non-stick agent in an amount up to about 6% by weight.

According to a second aspect of the present invention, there is provided a liquid edible product comprising a first liquid component, a second liquid component dispersed in the first liquid component to form an emulsion, and an emulsifier comprising a sucrose ester or a functionally equivalent derivative thereof.

According to a third aspect of the present invention, there is provided a liquid edible product comprising a first liquid component, a second liquid component dispersed in the first liquid component to form an emulsion, and an emulsifier which acts to reduce the surface tension between the first and second liquid components to stabilise the emulsion whilst maintaining a sprayable viscosity for the product.

The emulsifier preferably acts to form linkages, on a molecular scale, between the second liquid component and the first liquid component to maintain a generally uniform dispersion of the second liquid component in the first liquid component over a period of time, preferably at least fifty two weeks at temperatures up to 30° C. The emulsifier preferably has a hydrophilic-lipophilic balance (HLB) value of between 10 and 15. Preferably the emulsifier acts to impede movement of the second liquid component within the first liquid component. The second liquid component may comprise droplets dispersed within the first liquid component, and the emulsifier may act to inhibit coalescence of the droplets, and thereby stabilise the emulsion.

The first liquid component may comprise water, which may be present in an amount between 20-50% by weight of the product, and preferably in an amount between 28%-40% by weight of the product. Desirably the water is present in an amount about 33.6% by weight of the product.

The first liquid component may include a non-stick agent. The non-stick agent may be present in an amount up to about 10% by weight of the product, and more preferably in an amount up to about 6% by weight of the product. The non-stick agent may be a lecithin or a modification or derivative thereof. The lecithin may be a solid soya lecithin which may be present in an amount between 1-3% by weight of the liquid edible product. Alternatively, or in addition, the lecithin is preferably a liquid soya lecithin or a modified, fractionated or otherwise treated lecithin which may be present in an amount between 3-6% by weight of the liquid edible product, and desirably in an amount about 3.5 to 4.5% and desirably 3.9% by weight of the product.

A second emulsifier may be provided in the liquid edible product. The second emulsifier may comprise the or a further non-stick agent.

Preferably the emulsifier facilitates stabilisation of the lecithin in the product, and preferably acts to prevent the lecithin from clumping and thereby facilitating the formation and stabilisation of the product.

The first liquid component may include a preservative. The preservative may be present in an amount up to about 8% by weight of the product, and desirably in an amount between about 4-5.5% by weight of the product. The preservative may be present in an amount 0.05-8% by weight of the product, and desirably about 4.2% by weight of the product. Preferably the preservative comprises approximately 8-14%, and desirably approximately 10% by volume of the first liquid component. The preservative may comprise alcohol, which may be ethyl alcohol, isopropyl alcohol and propylalcohol. The preservative may additionally or as an alternative comprise one or more of propanol and iso-propanol.

The second liquid component may be present in an amount between 40-75% by weight of the product, and desirably in an amount between 50-65% by weight of the product. Preferably the second liquid component is present in an amount about 57.2% by weight of the product. The second liquid component preferably comprises an edible oil, and is preferably in a substantially liquid state at temperatures between about 5° C. and 100° C. The edible oil may comprise vegetable oil, olive oil, corn oil, sunflower oil, cotton oil, rapeseed oil or the like.

The liquid edible product may further comprise one or more of antioxidant, preservatives, flavouring, chelating agent, plant extract, herb extract, other emulsifiers, thickeners, spice extracts, colouring, vinegar, butter milk, milk product, butter oil, oil fraction, dairy derivative, milk protein, vitamins.

The liquid edible product may contain tocopherol, preferably in an amount in the order of 0.1% by weight of the product.

The emulsifier preferably comprises a sucrose ester of a fatty acid and may be present in an amount up to about 5% by weight of the product, and desirably in an amount between about 0.15-1.5% by weight of the product. Preferably the emulsifier is present in an amount about 1.0% by weight of the product.

The product may be an emulsion for use as a sprayable cooking oil, a dressing such as a salad dressing, a flavouring or other edible product.

According to a fourth aspect of the present invention there is provided a method of producing a sprayable liquid edible product, the method comprising forming an emulsion of a second liquid component in an amount between 40-75% by weight in a first liquid component in an amount between 20 and 50% by weight, stabilising the emulsion by providing therein a sucrose ester or a functionally equivalent derivative thereof in an amount up to about 5% by weight and providing a non-stick agent in an amount up to about 6% by weight of the product.

According to a fifth aspect of the present invention, there is provided a method of stabilising a liquid edible product having a second liquid component dispersed in a first liquid component to form an emulsion, the method comprising providing an emulsifier in the emulsion to reduce the surface tension between the first and second liquid components.

The emulsifier may comprise a sucrose ester or a functionally equivalent derivative thereof.

According to a sixth aspect of the present invention, there is provided a method of producing a liquid edible product, the method comprising forming an emulsion of a second liquid component in a first liquid component and stabilising the emulsion by providing therein a sucrose ester or a functionally equivalent derivative thereof.

According to a seventh aspect of the present invention, there is provided a dispensing container containing a liquid edible product as described above.

The container may be adapted to dispense the product in the form of a spray. The container may be an aerosol dispenser. Alternatively the container may be a finger pump actuated dispenser, a trigger spray pump, or any other suitable spray dispenser.

Preferred embodiments of the present invention will now be described by way of example only.

The invention provides a liquid edible product, which may include edible oil for use as a quick release coating or shallow fry cooking oil. The liquid edible product may alternatively or additionally comprise a dressing, such as a salad dressing, a flavouring, or other suitable sprayable food product.

The liquid edible product comprises generally a first liquid component and a second liquid component dispersed preferably in droplet form in the first liquid component to form an emulsion. The emulsion is of sprayable viscosity to enable the liquid edible product to be dispensed from a hand-held spray device, and includes a primary emulsifier which acts to reduce the surface tension between the first and second liquid components to stabilise the emulsion whilst maintaining the sprayability of the product.

In more detail according to one embodiment of the invention, the first liquid component comprises water which is preferably present in an amount about 33.6% by weight of the product. In alternative embodiments, the amount of water present is between 20-50% by weight of the product. The water may comprise purified water, potable water, spring water, mineral water, condensate, deionised, distilled, or may comprise other suitable edible water or any combination thereof.

In order to impart non-stick properties to the product, which are particularly desirable when the product is used as a quick release coating for cooking applications, a lecithin product, such as solid and/or liquid soya lecithin is provided in the emulsion. The lecithin product preferably comprises liquid soya lecithin present in an amount about 3.5% to 4.5% by weight of the liquid edible product. An amount of about 3.9% lecithin product has been found particularly preferable in the present example. Any lecithin product including lecithin derivatives, modified lecithins, treated lecithins and fractionated lecithins may be employed in an amount up to 10% by weight of the product.

The lecithin also has emulsifier properties and acts along with the primary emulsifier as will be described.

Advantageously, the first liquid component also includes a preservative in an amount 0.05% to 8% by weight of the product. In a preferred form the preservative is food grade ethyl alcohol present in an amount between 4.0 and 5.5% and desirably about 4.2% by weight of the product. Other suitable preservatives may be employed such as propylalcohol and iso-propylalcohol, either or both of which may be present as an alternative, or in addition, to the ethyl alcohol. In general, the preservative may be present in any amount up to about 8% by weight of the product.

The second liquid component comprises an edible oil, such as vegetable oil, olive oil, or the like, which is in a substantially liquid state at temperatures between 5° C. and 110° C. at normal atmospheric conditions of pressure, etc. Preferably the second liquid component is liquid at temperatures between 20° C. and 30° C. and preferably approximately room temperature. The edible oil is advantageously present in an amount about 57.2% by weight of the product, although it may be present in any amount between 40-75% by weight of the product.

Tocopherol is provided in an amount approximately 0.1% by weight of the composition. The tocopherol preferably acts as an antioxidant, slowing down the initiation stage of oxidation which can spoil the edible oil component.

In order to inhibit the natural tendency for the first and second liquid components of the emulsion to separate into discrete oil and water phases, the liquid edible product comprises a primary emulsifier which acts to reduce the surface tension between the first liquid component, namely the water, and the second liquid component, namely the edible oil. The primary emulsifier acts to form linkages, on a molecular scale, between the oil droplets and the first liquid component to prevent the oil droplets from coalescing thereby acting to stabilise the emulsion. Movement of the second liquid component, namely the oil, in the first liquid component is generally impeded. The viscosity of the resultant emulsion is not significantly increased by the emulsifier to ensure the product retains the desired sprayable characteristics, and therefore enables the liquid edible product to be reliably dispensed by spraying using conventional dispensing means.

The primary emulsifier preferably also acts to facilitate solubilisation or homogenous dispersion of the lecithin product and is therefore relatively hydrophilic in the emulsion. The hydrophilic-lipophilic (HLB) value is chosen to be between 10 and 15. The lecithin product itself has some emulsifier or stabilising effect on the emulsion as previously mentioned and the primary emulsifier's action on the lecithin product further improves the stability of the product.

A preferred primary emulsifier is a sucrose ester or a sucrose ester of a fatty acid which is desirably present in an amount about 1% by weight of the liquid edible product. The sucrose ester may however be present in any amount up to about 5% by weight of the product in the embodiments, provided that the emulsion remains of sprayable viscosity, as described above. Examples of suitable sucrose esters include those supplied by Stearinerie Dubois Fils, France under product name DUB SE 15S and by Sisterna B.V., The Netherlands under product name SISTERNA SP70/50. Sucrose esters suitable for use in accordance with the present invention have an HLB value of between 10 and 15.

In alternative embodiments, functionally equivalent derivatives of sucrose esters may be used as emulsifiers, either instead of or in addition to sucrose ester.

The products as described above remains generally homogenous for up to fifty two weeks at normal ambient room temperatures of between 15° C. and 25° C. on average, but up to 30° C.

The liquid edible product described above is produced by dispersing the lecithin product in the oil and then dispersing this in the first liquid component, namely the water, preservative and any other ingredients such as, vitamins, flavourings etc., to form an emulsion of sprayable viscosity, and providing therein the sucrose ester to stabilise the emulsion. Due to the action of the emulsifier the emulsion can be formed using relatively low energy techniques, such as, but not only, the use of a Silverson mixer. This provides for further advantage of the present invention.

For convenience of use, the liquid edible product is provided in a dispensing container in the form of a hand-held spray device. Either a finger pump actuated dispenser, an aerosol dispenser, a trigger pump or any other suitable spray dispenser both as described above, may be employed to dispense the product.

There is thus provided a liquid edible product in accordance with the present invention which has improved stability characteristics compared to conventional cooking oils of sprayable viscosity, and which at the same time remains of a viscosity which enables it to be reliably dispensed from a hand-held spray device without substantially affecting the spray characteristics of the resultant sprayed product. By maintaining a substantially uniform dispersion of the second liquid component in the first liquid component over a period of time, the emulsion remains stable for longer periods than existing sprayable liquid edible products. For example, emulsion stability may be increased on average by three months, and indeed up to six months.

Although embodiments of the invention have been described in the preceding paragraphs, it should be appreciated that various modifications may be made without departing from the scope of the present invention. The lecithin product may comprise a physically or chemically modified lecithin or lecithin derivative, or may be liquid or powder lecithin product, or of any form or origin. The product may comprise any other suitable components, such as antioxidant, preservative, flavouring, chelating agent, plant extract, herb extract, other emulsifiers, thickeners, spice extracts, colouring, vinegar, butter milk, milk product, butter oil, oil fraction, dairy derivative, milk protein, vitamin.

Whilst endeavouring in the foregoing specification to draw attention to those features of the invention believed to be of particular importance, it should be understood that the Applicant claims protection in respect of any patentable feature or combination of features hereinbefore referred to and/or shown in the drawings, whether or not particular emphasis has been placed thereon.

1-58. (canceled)

59. A sprayable liquid edible product comprising a first liquid component in an amount between 20 and 50% by weight, a second liquid component in an amount between 40-75% by weight dispersed in the first liquid component to form an emulsion, an emulsifier comprising a sucrose ester or a functionally equivalent derivative thereof in an amount up to about 5% by weight and a non-stick agent in an amount up to about 6% by weight.

60. A liquid edible product according to claim 59, in which the emulsifier has a hydrophilic-lipophilic balance (HLB) value of between 10 and 15.

61. liquid edible product according to claim 59, in which the emulsifier acts to impede movement of the second liquid component within the first liquid component.

62. A liquid edible product according to claim 59, in which the second liquid component comprises droplets dispersed within the first liquid component and the emulsifier acts to inhibit coalescence of the droplets and thereby stabilise the emulsion.

63. A liquid edible product according to claim 59, in which the first liquid component comprises water.

64. A liquid edible product according to claim 59, in which the first liquid component is present is an amount between 28%-40% by weight of the product.

65. A liquid edible product according to claim 63, in which the water is present in an amount about 33.6% by weight of the product.

66. A liquid edible product according to claim 59, in which the first liquid component includes a non-stick agent.

67. A liquid edible product according to claim 59, in which the non-stick agent is a lecithin or a modification or derivative thereof.

68. A liquid edible product according to claim 67, in which the lecithin is a solid soya lecithin present in an amount between 1-3% by weight of the liquid edible product.

69. A liquid edible product according to claim 67, in which the lecithin is a liquid soya lecithin or a modified, fractionated or otherwise treated lecithin present in an amount between 3-6% by weight of the liquid edible product.

70. A liquid edible product according to claim 69, in which the lecithin is present in an amount about 3.5 to 4.5%.

71. A liquid edible product according to claim 67, in which the lecithin is present in an amount 3.9% by weight of the product.

72. A liquid edible product according to claim 59, in which a second emulsifier is provided in the liquid edible product.

73. A liquid edible product according to claim 72, in which the second emulsifier comprises the or a further non-stick agent.

74. A liquid edible product according to claim 72, in which the emulsifier facilitates stabilisation of the lecithin in the product.

75. A liquid edible product according to claim 72, in which the emulsifier acts to prevent the lecithin from clumping and thereby facilitating the formation and stabilisation of the product.

76. A liquid edible product according to claim 59, in which the first liquid component includes a preservative.

77. A liquid edible product according to claim 76, in which the preservative is present in an amount up to about 8% by weight of the product.

78. A liquid edible product according to claim 77, in which the preservative is present in an amount 0.05-8% by weight of the product.

79. A liquid edible product according to claim 76, in which the preservative is present in an amount between about 4-5.5% by weight of the product.

80. A liquid edible product according to claim 76, in which the preservative is present in an amount about 4.2% by weight of the product.

81. A liquid edible product according to claim 76, in which the preservative comprises approximately 8-14% by volume of the first liquid component.

82. A liquid edible product according to claim 76, in which the preservative comprises approximately 10% by volume of the first liquid component.

83. A liquid edible product according to claim 76, in which the preservative comprises alcohol, such as ethyl alcohol, isopropyl alcohol propylalcohol, propanol and iso-propanol.

84. A liquid edible product according to claim 59, in which the second liquid component is present in an amount between 50-65% by weight of the product.

85. A liquid edible product according to claim 59, in which the second liquid component is present in an amount about 57.2% by weight of the product.

86. A liquid edible product according to claim 59, in which the second liquid component comprises an edible oil.

87. A liquid edible product according to claim 59, in which the second liquid component is in a substantially liquid state at temperatures between about 5° C. and 100° C.

88. A liquid edible product according to claim 86, in which the edible oil comprises vegetable oil, olive oil, corn oil, sunflower oil, cotton oil, rapeseed oil.

89. A liquid edible product according to claim 59, in which the liquid edible product further comprises one or more of antioxidant, preservatives, flavouring, chelating agent, plant extract, herb extract, other emulsifiers, thickeners, spice extracts, colouring, vinegar, butter milk, milk product, butter oil, oil fraction, dairy derivative, milk protein, vitamins.

90. A liquid edible product according to claim 59, in which the liquid edible product contains tocopherol.

91. A liquid edible product according to claim 90, in which the tocopherol is present in an amount in the order of 0.1% by weight of the product.

92. A liquid edible product according to claim 59, in which the emulsifier comprises a sucrose ester of a fatty acid.

93. A liquid edible product according to claim 59, in which the emulsifier is present in an amount between about 0.15-1.5% by weight of the product.

94. A liquid edible product according to claim 59, in which the emulsifier is present in an amount about 1.0% by weight of the product.

95. A liquid edible product according to claim 59, in which the product is an emulsion for use as a sprayable cooking oil, a dressing such as a salad dressing, a flavouring or other edible product.

96. A method of producing a sprayable liquid edible product, the method comprising forming an emulsion of a second liquid component in an amount between 40-75% by weight in a first liquid component in an amount between 20 and 50% by weight, stabilising the emulsion by providing therein a sucrose ester or a functionally equivalent derivative thereof in an amount up to about 5% by weight and providing a non-stick agent in an amount up to about 6% by weight of the product.

97. A dispensing container containing a liquid edible product as claimed in claim 59.

98. A dispensing container according to claim 97, in which the container is adapted to dispense the product in the form of a spray.

99. A dispensing container according to claim 97, in which the container is an aerosol dispenser.

100. A dispensing container according to claim 97, in which the container is a finger pump actuated dispenser or a trigger spray pump.

101. A liquid edible product comprising a first liquid component, a second liquid component dispersed in the first liquid component to form an emulsion, and an emulsifier comprising a sucrose ester or a functionally equivalent derivative thereof.

102. A liquid edible product comprising a first liquid component, a second liquid component dispersed in the first liquid component to form an emulsion, and an emulsifier which acts to reduce the surface tension between the first and second liquid components to stabilise the emulsion whilst maintaining a sprayable viscosity for the product.

103. A method of stabilising a liquid edible product having a second liquid component dispersed in a first liquid component to form an emulsion, the method comprising providing an emulsifier in the emulsion to reduce the surface tension between the first and second liquid components.

104. A method according to claim 103, in which the emulsifier comprises a sucrose ester or a functionally equivalent derivative thereof.

105. A method of producing a liquid edible product, the method comprising forming an emulsion of a second liquid component in a first liquid component and stabilising the emulsion by providing therein a sucrose ester or a functionally equivalent derivative thereof.
